(19) United States
(12) Patent Application Publication
(10) Pub. No.: US 2002/0073421 A1
(43) Pub. Date: Jun. 13, 2002

(54) System for targeted advertisement, personal editing and parental control in a television network

(76) Inventors: Gutman Levitan, Stamford, CT (US); Howard B. Krass, Miami, FL (US)

Correspondence Address: Allen M. Krass, GIFFORD, KRASS, GROH, SPRINKLE,, ANDERSON & CITKOWSKI, P.C., 280 N. Old Woodward, Suite 400, Birmingham, MI, 48009, US

(21) Appl. No.: 09/732,695

(22) Filed: Dec. 8, 2000

Related U.S. Application Data
(60) Provisional application No. 60/170,109, filed on Dec. 10, 1999.

(51) Int. Cl. H04N 7/16; H04N 7/025; H04N 7/10

(52) U.S. Cl. 725/28; 725/25; 725/34

(57) ABSTRACT

A system for automatic personal editing of television programs based on viewer's information privately stored in viewer's computerized television receivers. The system, when activated, protects viewers, first of all children, filtering out everything that is unacceptable or useless. The filtering is carried out on three levels: blocking television programs, blocking some parts of the programs and replacing some parts by alternative video fragments. In particular, the system replaces a television commercial meaningless for a viewer by a commercial that may be of certain interest to the viewer. Another application is an improvement in management of controversial matter such as sex and violence. Depending on viewer's preferences the system replaces a certain scene by a commercial or restores such a scene if it has been replaced by a commercial in a program edited for broadcast television. The replacement technique uses basic channels for transmission of primary versions of television programs and auxiliary channels for transmission of alternative video fragments intended for replacement of some parts of the primary versions. A computerized receiver makes a decision on a replacement comparing viewer's information with information on the primary and alternative parts.

### RELATED APPLICATION

This application claims priority of United States Provisional Patent Application 60/170,109 filed Dec. 10, 1999, and is incorporated herein by reference.

### BACKGROUND OF THE INVENTION

This invention relates to information technology for television and more particularly, to an emerging medium referred as personal television.

U.S. Pat. No. 5,534,911 discloses an apparatus for providing a customer of a television system with virtual personal channel, which is viewer's interface to hundred-channel television. The technology is based on comparison of television programs data in a timetable file with viewer's profile data stored in a viewer's computerized receiver. Virtual personal channel, when selected, delivers television programs of the most personal interest at a time selected by viewer no matter on which channel and at what time the programs are physically transmitted. In addition, it protects viewer from everything that is going to be boring, annoying, useless or unacceptable for any reason. At the same time, all conventional channels are also available for viewer and he can select television programs on his own. When doing so, viewer still could be protected and served in a personal manner by a profile control system.

This application discloses a system for automatic personal editing of television programs based on viewer's information privately stored in viewer's computerized television receivers. The system, when activated, works with personal and all other channels filtering out everything that is useless or unacceptable. The difference is that with personal channels the profile control provides both automatic selection and editing of television programs while with conventional channels, the editing only. Viewer has also an option to turn off the profile control to put his receiver in a conventional mode without any personal features. The personal editing is carried out on three levels: blocking television programs, blocking some parts of the programs and replacing some parts by alternative video fragments. It also has three major applications: targeted advertisement, parental control and multi-versioned programming.

U.S. Pat. No. 5,864,823 applies the concept of virtual personal channel to advertisement in order to provide a new type of advertising, commercial-on-demand (COD), which, in turn, is incorporated with the Internet to facilitate a highly automated home shopping system—virtual personal store. COD is a civilized alternative of annoying junk mail and solicitation by phone. Advertising a product or a service it goes only to those recipients whose consumer profiles indicate an interest in that kind of product or service. And it is incredibly affordable because it doesn't need to be inserted in an entertainment program: client computers automatically pick it up from any channel at any transmission time. However COD cannot completely replace commercials included in television programs partly because TV viewers are lazy and partly because there are commercials with no demand such as those intended for establishing and maintaining a brand name. A system for targeted television advertisement, disclosed in the present application, replaces a commercial included in a television program by an alternative commercial transmitted via an auxiliary channel, if the included commercial is meaningless for a particular viewer while the alternative commercial may be of some interest to the viewer. In such a system, viewers receive more relevant advertising information and advertisers can effectively use viewers' information while having no access to that information. In addition, alternative commercials may be permissible for tobacco, liquor and other products prohibited for television advertisement because alternative commercials are transmitted over auxiliary channels and filtered by profile control.

Children are a category of viewers that do not develop their profiles themselves. Parents may develop a profile for their children or better select one from a list of profiles recommended by community leaders. If a children profile is set it must be the default profile while profiles of other family members and the profile-off option must be protected by secret two-digit codes.

The multi-versioned programming may have different forms. Depending on viewer's preferences the system may replace a certain scene with a controversial matter, such as sex or violence, by a commercial, or restore such a scene if it has been replaced by a commercial in a program edited for broadcast television. A futuristic application of the technique is a simulcast of multiple versions of the same television program, such as adult and family versions of a show, or a movie with and without a happy ending.

### SUMMARY OF THE INVENTION

Accordingly, it is an object of the present invention to provide a system for automatic personal editing of television programs based on viewer's information privately stored in viewer's computerized television receivers. The system, when activated, protects viewers, first of all children, filtering out everything that is going to be useless or unacceptable for any reason. The filtering is carried out on three levels: blocking television programs, blocking some parts of the programs and replacing some parts by alternative video fragments.

Another object of the present invention is to provide a system for targeted television advertisement based on viewer's information stored in a computerized receiver. The system replaces a commercial included in a television program by an alternative commercial transmitted via an auxiliary channel if the included commercial is meaningless for a particular viewer while the alternative commercial may be of some interest to the viewer. In such a system, viewers receive more relevant advertising information and advertisers can effectively use viewers' information while having no access to that information.

A further object is an improvement in management of controversial matter such as violence, sex and explicit language. Depending on viewer's preferences the system may replace a certain scene by a commercial or restore such a scene if it has been replaced by a commercial in a program edited for broadcast television.

A still further object is a tool for creation and simultaneous delivery of multiple versions of the same television program, such as adult and family versions of a show, or a movie with and without a happy ending.

In keeping with these objects, one feature of present invention resides, briefly stated, in basic channels for transmitting primary versions of television programs containing some parts, defined as primary components, that may be replaced by alternative video fragments, defined as alternative components; auxiliary channels for transmitting the alternative components; a data transmitter for transmitting a timetable file with descriptive and time/channel data of all scheduled primary and alternative components with primary components linked to their alternative components and alternative components scheduled for transmission prior to or simultaneously with corresponding primary component; a data receiver for receiving the timetable file; a selector of basic channels; an additional selector of auxiliary channels; a recorder connected to the additional channel selector for recording alternative components; and a computer storing viewer's data and coupled to the data receiver and both channel selectors for obtaining the descriptive and time/channel data of all scheduled primary and alternative components, using the data for determining which primary component will be running on a currently selected basic channel and which alternative components are available for replacement of that primary component, comparing viewer's data with data of primary and alternative components, making a decision on a presentation of the primary component to viewer or its replacement by an alternative component, and when a decision on a replacement is made, recording a selected alternative component at the time of its transmission and playing it back at the time of transmission of the primary component.

The novel features, which are considered as characteristic for the present invention, are set forth in particular in the appended claims. The invention itself, however, both as to its construction and its method of operation will be best understood from the following description of specific embodiments when read in connection with the accompanying drawings.

### BRIEF DESCRIPTION OF THE DRAWING FIGURES

FIG. 1 is a view showing a block diagram of a personal television system.

FIG. 2 is a view showing a block diagram of a simple personal television client.

FIG. 3 is a view showing a block diagram of an improved personal television client.

FIG. 4 shows a layout of a window for viewer's profile selection.

### DESCRIPTION OF THE PREFERRED EMBODIMENTS

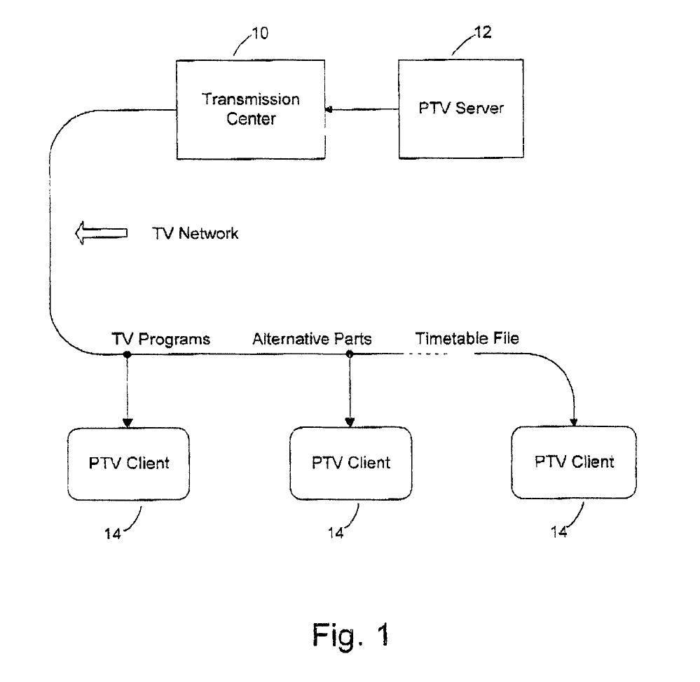

A block diagram of the system providing features of personal television is shown on FIG. 1. At the transmitting end it consists of a television transmission center 10 and a server computer 12 associated with the television center. To distinguish the server as a provider of personal television it is referred herein as PTV Server. The server communicates with computerized television receivers, referred herein as PTV Clients 14, via a one-way television network, which may be a terrestrial broadcast or satellite or cable system. The PTV Server hosts a database of records on television programs and when a program is scheduled for transmission its record is supplemented with time/channel data and unloaded in a Timetable File transmitted via TV network prior to the program. The Timetable file is a TV guide for PTV Clients. On the other side, each PTV Client stores viewer's profile, that is data representing viewer's interests and preferences as well as viewer's objections related to different kinds of controversial matter such as sex, violence, “adult” language, horror, indecency and so on. Client computers process profile data in conjunction with the Timetable File for compiling personal channels as described in U.S. Pat. No. 5,534,911.

Virtual personal channel is viewer's interface to hundred-channel television: it delivers television programs of the most personal interest at a time selected by viewer no matter on which channel and at what time the programs are physically transmitted. In addition, it protects viewer from everything that is going to be boring, annoying, useless or unacceptable for any reason. At the same time, all conventional channels are available for viewer and he can select television programs on his own. When doing so, viewer still could be protected and served in a personal manner by a profile control system as described hereafter.

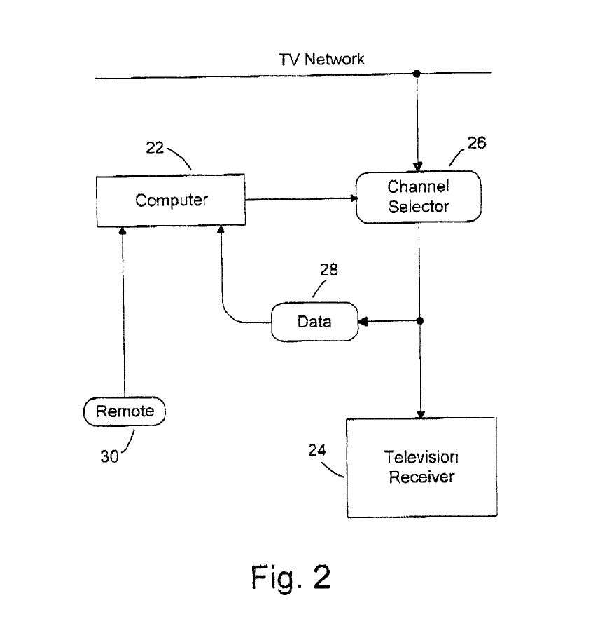

A block diagram of PTV Client is shown on FIG. 2. It combines a computer 22 storing viewer's data and a television receiver 24 connected to TV network via a channel selector 26. The computer receives a timetable file via the channel selector and a data interface 28. Viewer selects channels using a remote control 30, however a number of selected channel is received first by the computer and then transferred to the channel selector. If viewer selects personal channel, which is a compiled one, the computer automatically selects a physical channel on which a television program of the most personal interest is currently transmitted. In any case the computer knows which channel is currently selected. It checks time/channel data of scheduled programs to determine which program is currently selected, and compares descriptive data of that program with viewer's profile data. If the program contains any controversial material unacceptable for viewer the computer, which controls the channel selector 26, prevents reception of the program and produces a message like “Profile control. Please select other channel” on the screen of the television receiver 24.

Some television programs need to be blocked not completely but only in some parts with unacceptable materials. In order to achieve the goal, the timetable file contains descriptive and time/channel data of those parts and the client computer is blocking the channel selector during their transmission only.

Another option of personal editing is replacing some parts of a television program by alternative video fragments. The technique may have different applications including management of controversial matter, targeted advertisement and production of multiple versions of television programs running simultaneously.

A system providing that kind of editing contains conventional television channels for transmission of conventional television programs with commercials included in those programs, referred herein respectively as basic channels, primary versions of TV programs and primary commercials. Viewers with conventional television receivers, not PTV Clients, watch those primary TV programs with primary commercials only. The primary programs however contain some parts, defined as primary components, that may be replaced by alternative video fragments, defined as alternative components. In particular, the replaceable parts are commercials that don't make any sense for some viewers. The alternative components are transmitted over additional, auxiliary channels. The timetable file contains descriptive and time/channel data of all scheduled primary and alternative components, and each primary component in the file are linked to its alternative components, and alternative components are scheduled for transmission simultaneously with corresponding primary components. The client computer 22 (FIG. 2) checks time/channel data of scheduled primary and alternative components to determine which primary component will be running on the currently selected basic channel and which alternative components are available for replacement of that primary component. Comparing viewer's data with descriptive data of primary and alternative components the computer makes a decision on presentation of the primary component to viewer or a replacement of the primary component by an alternative component. If a decision on a replacement is made, it switches channel selector 26 at the time of transmission of the primary component from the basic channel to an auxiliary channel on which a selected alternative component is transmitted.

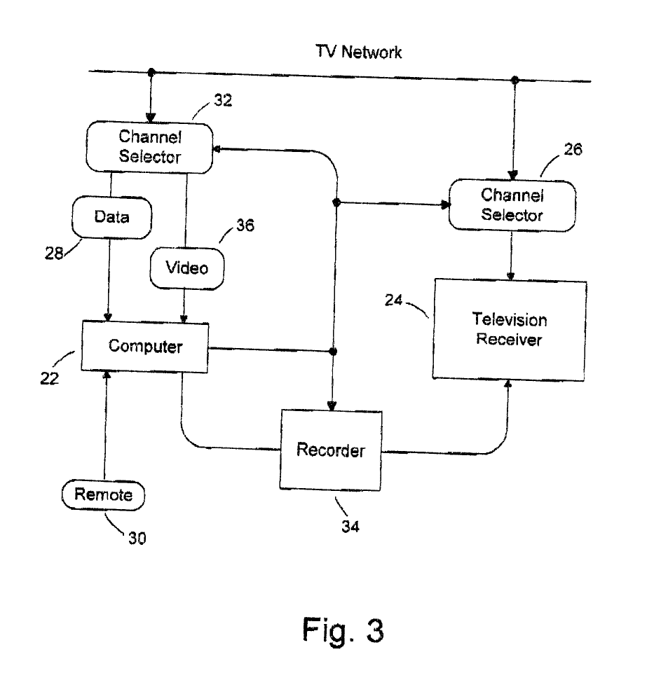

The PTV Client shown on FIG. 2 however makes a bad usage of auxiliary channels. If commercials typically take 25% of time then auxiliary channels idle 75% of time. Moreover, if more than one alternative component is defined for the same primary component then more than one auxiliary channel is required for transmission of those alternative components simultaneously with the primary component. A block diagram of an improved version is shown on FIG. 3. It features a separate channel selector 32 for selecting auxiliary channels and a recorder 34 connected to the channel selector for recording alternative components. The recorder is a computer hard drive or a rewritable DVD (DWD-RW) drive. The computer receives a timetable file via the channel selector 32 and the data interface 28. The timetable file contains descriptive and time/channel data of all scheduled primary and alternative components, however alternative components are scheduled for transmission not simultaneously with but prior to corresponding primary component. Client computer 22 checks which alternative components are available for replacement of a primary component and makes a decision on presentation of the primary component to viewer or a replacement of the primary component by an alternative component. If a decision on a replacement is made the computer switches channel selector 32 at the time of transmission of a selected alternative component to an auxiliary channel on which the selected alternative component is transmitted and provides recording of the component by the recorder 34. Then it plays back the recorded component at the time of transmission of the primary component thereby replacing the primary component. In this way, more than one alternative component for the same primary component can be transmitted on the same auxiliary channel. In addition, auxiliary channels can be shared for transmission of alternative components related to different concurrently transmitted television programs.

Viewer's data are acquired in an interactive profile development session. In the session, computer presents lists to select from and questions with multiple choice of answers. Then it processes viewer's responses and sets viewer's profile. It is up to viewer how much he or she wants to customize the television receiver when setting the profile. Some tiny pieces of information, such as age and gender, can make a big difference for targeted advertisement. Telemarketing companies are effectively using demographic information associated with zip code. However if, for example, headache is not your problem, you may have headache pills on your screen to be replaced by something more appropriate. The profile data are privately stored in the client computer not accessible for anybody but viewer and therefore advertisers can effectively use viewers' information while having no access to that information.

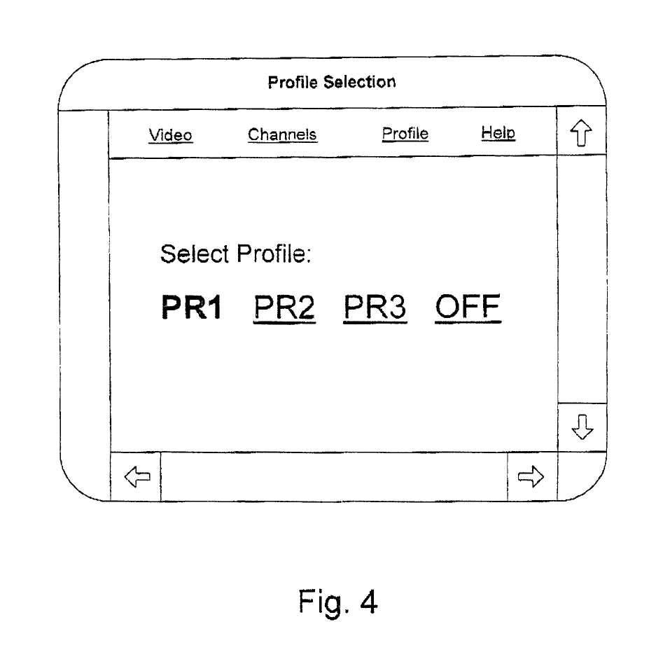

A television receiver shared by more than one viewer may store several profiles so to provide a personal profile for each family member plus a common, family profile. FIG. 4 shows a profile selection window with an active profile highlighted. When a receiver is turned on, it is under control of last active profile or a default profile defined for the receiver. Selecting option OFF, viewer disables profile control at all to put his television receiver in the conventional, not PTV, mode.

There is a category of viewers that do not develop their profiles themselves: children. Parents may develop a profile for their children or select it from a list of recommended ones. Items of the list may look like “Hasidic children from 8 to 12”. If a children profile is set it is the default profile while all other profiles and the option OFF are protected by secret two-digit codes. Children feel free selecting channels but can watch only what their parents consider as appropriate. To make a feeling of the profile control gentler the client computer outputs for children a funny still picture instead of a message about blocking a TV program.

While certain novel features of this invention have been shown and described, it will be understood that various omissions, substitutions and changes in the forms and details of the devices illustrated and their operation can be made by those skilled in the art without departing from the spirit of the invention. In particular, the timetable file can be delivered from PTV Server to PTV Clients via a television channel, which is preferable, or via a computer network.

What is claimed is:

1. A system for selective protection of television viewer against television programs containing controversial materials, said protection based on viewer's information stored in viewer's receiver, said system comprising:
means for transmitting a timetable file with descriptive and time/channel data of scheduled television programs prior to transmission of the programs, said descriptive data specifying controversial materials contained in the programs;
a channel selector for selection of television programs at viewer's end;
means for receiving said timetable file at viewer's end; and
control means storing viewer's data specifying controversial materials unacceptable for viewer, said control means coupled to said means for receiving timetable file and said channel selector and operative for obtaining said descriptive and time/channel data of scheduled television programs, using the time/channel data for determining which television program is transmitted on a currently selected channel, comparing the descriptive data of the television program with said viewer's data and making a decision on a presentation of the program to viewer or blocking said channel selector for preventing the presentation.

2. A system as defined in claim 1 wherein said viewer's information stored in viewer's receiver is specified by parents for their children for providing parental control.

3. A system for a selective protection of television viewer against controversial materials in television programs said protection based on viewer's information stored in viewer's receiver, said system comprising:
means for transmitting a timetable file with descriptive and time/channel data of scheduled television programs prior to transmission of the programs, said data specifying parts of the television programs containing controversial materials;
a channel selector for selection of television programs at viewer's end;
means for receiving said timetable file at viewer's end; and
control means storing viewer's data specifying controversial materials unacceptable for viewer, said control means coupled to said means for receiving timetable file and said channel selector and operative for obtaining said descriptive and time/channel data of scheduled television programs, using the time/channel data for determining which television program is transmitted on a currently selected channel and which part of the program containing a controversial material will be running next, comparing the descriptive data of that part with said viewer's data and making a decision on a presentation of the part to viewer or blocking said channel selector at the time of transmission of the part for preventing the presentation.

4. A system as defined in claim 3 wherein said viewer's information stored in viewer's receiver is specified by parents for their children for providing parental control.

5. A system for delivery of different versions of the same television program depending on viewer's information stored in viewer's receiver, comprising:
basic channels for transmitting primary versions of television programs containing some parts, defined as primary components, that may be replaced by alternative video fragments, defined as alternative components, for producing alternative versions of those television programs;
auxiliary channels for transmitting said alternative components;
means for transmitting a timetable file with descriptive and time/channel data of scheduled primary and alternative components wherein each primary component is linked to its alternative components and alternative components are scheduled for transmission simultaneously with corresponding primary component;
means for receiving said timetable file;
a channel selector; and
control means coupled to said means for receiving timetable file and said channel selector, said control means storing viewer's data and operative for obtaining said descriptive and time/channel data of scheduled primary and alternative components, using the time/channel data for determining which primary component will be running on a currently selected basic channel and which alternative components are available for replacement of that primary component, comparing said viewer's data with said descriptive data of primary and alternative components, making a decision on a presentation of the primary component to viewer or a replacement of the primary component by an alternative component and, when a decision on a replacement is made, switching said channel selector at the time of transmission of the primary component from the basic channel to an auxiliary channel on which a selected alternative component is transmitted for replacing the primary component by the alternative component.

6. A system as defined in claim 5 and further comprising a separate channel selector for selecting said auxiliary channels and a recorder connected to the channel selector for recording said alternative components wherein alternative components are transmitted and, if selected, recorded prior to transmission of corresponding primary component, and played back at the time of transmission of the primary component for replacing the primary component by a selected alternative component.

7. A system as defined in claim 5, wherein said primary and alternative components are television commercials.
